(19) United States
(12) Patent Application Publication
(10) Pub. No.: US 2024/0040164 A1
(43) Pub. Date: Feb. 1, 2024

(54) OBJECT IDENTIFICATION AND SIMILARITY ANALYSIS FOR CONTENT ACQUISITION

(71) Applicant: ROKU, INC., San Jose, CA (US)

(72) Inventors: Ronica JETHWA, San Jose, CA (US); Fei XIAO, San Jose, CA (US)

(73) Assignee: ROKU, INC., San Jose, CA (US)

(21) Appl. No.: 17/815,880

(22) Filed: Jul. 28, 2022

(51) Int. Cl. H04N 21/234; H04N 21/258; H04N 21/25

(52) U.S. Cl. CPC H04N 21/23418; H04N 21/25883; H04N 21/251

(57) ABSTRACT

Disclosed herein are system, apparatus, article of manufacture, method and/or computer program product embodiments, and/or combinations and sub-combinations thereof, for object identification and similarity analysis for content acquisition. An example embodiment operates by determining a first content item based on an amount of requests for the first content item. A first object may be identified based on an amount of instances that the first object is indicated by the first content item. Based on the first object, demographic information for the first content item may be determined. A second content item may then be requested based on an amount of attributes of the first object matching an amount of attributes of a second object indicated by the second content item, and the demographic information for the first content item matching demographic information for the second content item.

### BACKGROUND

### Field

This disclosure is generally directed to content management, and more particularly to object recognition and classification based on content item analysis

### Background

Content and/or content items (e.g., animated content, cartoons, television programs, video, etc.) typically include objects (e.g., characters, actors, devices, vehicles, etc.) that attract attention. For example, toddler-aged users/viewers (and/or related demographic) may be attracted to trucks and/or animated animals depicted in cartoons, and teenage users/viewers (and/or related demographic) may be attracted to swords or other weapons depicted in anime programs. Users, viewers, content consumers, and/or the like may indicate attractive content objects via online surveys, portals, and/or other feedback processes. However, content distribution systems/devices, content management systems/devices, content access systems/devices, and/or the like are unable to identify the most popular content objects to support content acquisition requests, proposals, and/or the like without participation and/or manual effort from users, viewers, and/or content consumers. Content distribution systems/devices, content management systems/devices, content access systems/devices, and/or the like are also unable to automatically identify the most popular content objects to support content acquisition requests, proposals, and/or the like; Mechanisms such as online surveys, portals, and/or other feedback processes for identifying popular content and/or content items are subject to errors, misinformation, lack of user participation, and routinely fail to provide an accurate indication of the most popular content objects in the most popular content and/or content items.

### SUMMARY

Provided herein are system, apparatus, article of manufacture, method and/or computer program product embodiments, and/or combinations and sub-combinations thereof, for object identification and similarity analysis for content acquisition. According to some aspects of this disclosure, a computing system may identify the most engaged (e.g., requested, accessed, displayed, communicated, etc.) content items (e.g., animated shows, cartoons, programs, videos, etc.) by various cohorts (e.g., user types, device types, etc.). For example, the most requested and/or most popular cartoons and/or animated shows may be determined. According to some aspects of this disclosure, objects (e.g., characters, shapes, colors, animals, vehicles, etc.) that appear (e.g., are indicated, represented, included, etc.) the most in the most engaged content items may be used to determine target demographic information for the most engaged content items. For example, cartoon objects (e.g., animated vehicles, animated animals, animated clothing types, etc.) included with the most requested and/or most popular cartoons and/or animated shows may be identified, and a predictive model and/or the like may forecast and/or indicate corresponding demographic information.

According to some aspects of this disclosure, additional content items associated with demographic information that corresponds to the target demographic information for the most engaged content items, and include enough similar objects as the objects that appear the most in the most engaged content items may be requested, selected, acquired, and/or the like. For example, if a popular cartoon and/or animated show includes multiple occurrences of race cars, and the animation and/or type of representation for the race cars suggests the cartoon and/or animated show belongs to a particular genre (e.g., anime, situational drama, children, adult, etc.), additional cartoons and/or animated shows that correspond to the genre and include a certain amount of occurrences of race cars (or similar objects) may be requested.

According to some aspects of this disclosure, an example embodiment operates by determining a first content item based on an amount of requests for the first content item. For example, a first object may be identified based on an amount of instances that the first object is indicated by the first content item. Based on the first object, demographic information for the first content item may be determined. A second content item may be requested based on an amount of attributes of the first object matching an amount of attributes of a second object indicated by the second content item, and the demographic information for the first content item matching demographic information for the second content item.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example system for training a content analysis module that may be used for object identification and similarity analysis for content acquisition, according to some embodiments.

FIG. 4 illustrates a flowchart of an example training method for generating a machine learning classifier to classify content item data used for object identification and similarity analysis for content acquisition, according to some embodiments.

FIG. 5 illustrates a flowchart of an example method for object identification and similarity analysis for content acquisition, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for object identification and similarity analysis for content acquisition.

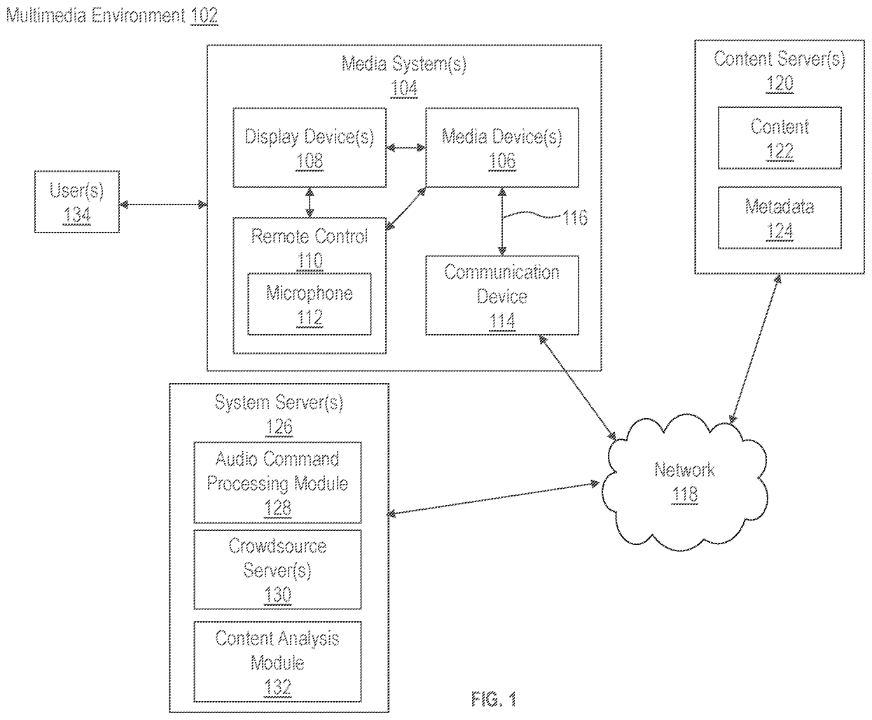

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 134 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

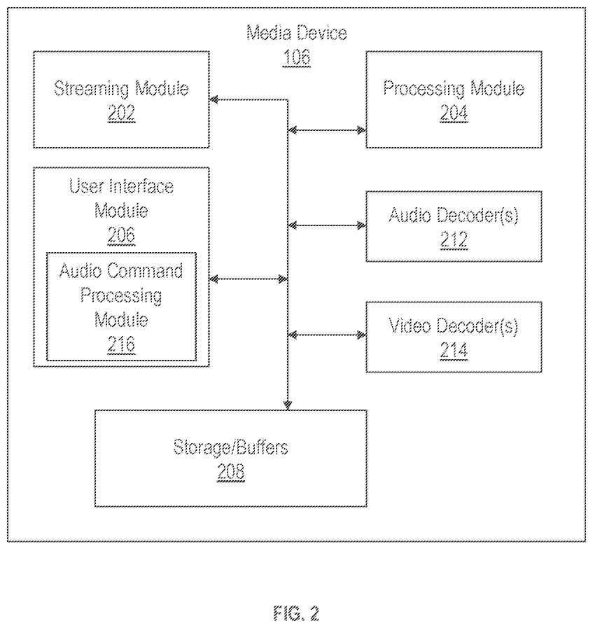

FIG. 2 illustrates a block diagram of an example media device 106, according to some embodiments. Media device 106 may include a streaming module 202, processing module 204, storage/buffers 208, and user interface module 206. The user interface module 206 may include an audio command processing module 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Similarly, each video decoder 214 may be configured to decode video of one or more video formats, such as but not limited to MP4 (mp4, m4a, m4v, f4v, f4a, m4b, m4r, f4b, mov, etc.), 3GP (3gp, 3gp2, 3g2, 3gpp, 3gpp2, etc.), OGG (ogg, oga, ogv, ogx, etc.), WMV (wmv, wma, asf, etc.), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Returning to FIG. 1, each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short-range, long-range, local, regional, global communications mechanism, means, approach, protocol and/or network, as well as any combination(s) thereof.

Media system 104 may include a remote control 110. The remote control 110 can be any component, part, apparatus, and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels, or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of content items, music, videos, movies, TV programs, multimedia, images, still pictures, text, graphics, gaming applications, advertisements, programming content, public service content, government content, local community content, software, and/or any other content and/or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, objects depicted in content and/or content items, object types, closed captioning data/information, audio description data/information, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system server(s) 126. The system server(s) 126 may operate to support the media devices 106 from the cloud. It is noted that the structural and functional aspects of the system server(s) 126 may wholly or partially exist in the same or different ones of the system server(s) 126.

The system server(s) 126 may include an audio command processing module 128. As noted above, the remote control 110 may include a microphone 112. The microphone 112 may receive audio data from users 134 (as well as other sources, such as the display device 108). In some embodiments, the media device 106 may be audio responsive, and the audio data may represent verbal commands from the user 134 to control the media device 106 as well as other components in the media system 104, such as the display device 108.

In some embodiments, the audio data received by the microphone 112 in the remote control 110 is transferred to the media device 106, which is then forwarded to the audio command processing module 128 in the system server(s) 126. The audio command processing module 128 may operate to process and analyze the received audio data to recognize the user 134's verbal command. The audio command processing module 128 may then forward the verbal command back to the media device 106 for processing.

In some embodiments, the audio data may be alternatively or additionally processed and analyzed by an audio command processing module 216 in the media device 106 (see FIG. 2). The media device 106 and the system server(s) 126 may then cooperate to pick one of the verbal commands to process (either the verbal command recognized by the audio command processing module 128 in the system server(s) 126, or the verbal command recognized by the audio command processing module 216 in the media device 106).

Now referring to both FIGS. 1 and 2, in some embodiments, the user 134 may interact with the media device 106 via, for example, the remote control 110. For example, the user 134 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 134.

In streaming embodiments, the streaming module 202 may transmit the content to the display device 108 in real-time or near real-time as it receives such content from the content server(s) 120. In non-streaming embodiments, the media device 106 may store the content received from content server(s) 120 in storage/buffers 208 for later playback on display device 108.

According to some aspects of this disclosure, the media devices 106 may exist in thousands or millions of media systems 104. Accordingly, the media devices 106 may lend themselves to crowdsourcing embodiments and, thus, the system server(s) 126 may include one or more crowdsource server(s) 130.

According to some aspects of this disclosure, using information received from the media devices 106 in the thousands and millions of media systems 104, the crowdsource server(s) 130 may identify similarities and overlaps between closed captioning requests issued by different users 134 watching a particular movie. Based on such information, the crowdsource server(s) 130 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 130 may operate to cause closed captioning to be automatically turned on and/or off during future streamings of the movie.

According to some aspects of this disclosure, using information received from the media devices 106 in the thousands and millions of media systems 104, the crowdsource server(s) 130 may identify popular content and/or content items (e.g., animated content, cartoons, television programs, video, etc.). For example, the most popular content and/or content items may be determined based on the amount of content and/or content items are requested (e.g., viewed, accessed, etc.) by media devices 106. The crowdsource server(s) 130 may identify similarities, such as common attributes, features, elements, and or the like, between content and/or content items. For example, the crowdsource server(s) 130 may detect and classify similar cartoon objects across all animated content and/or content items. The crowdsource server(s) 130 may detect and classify any attribute, feature, element, object, and/or the like associated with or depicted by any type of content and/or content items.

According to some aspects of this disclosure, the system server(s) 126 may include a content analysis module 132. The content analysis module 132 may use processing techniques, such as artificial intelligence, statistical models, logical processing algorithms, and/or the like for object and/or object type classification. For example, the content analysis module 132 may facilitate object identification and similarity analysis for content acquisition. The content analysis module 132 may use various processing techniques to make suggestions, provide feedback, or provide other aspects. According to some aspects of this disclosure, the content analysis module 132 may use classifiers that map an attribute vector to a confidence that the attribute belongs to a class. For example, the content analysis module 132 may use classifiers that map vectors that represent attributes of objects detected and/or extracted from animated content to a confidence that the attributes belong to various types of cartoon objects (e.g., animated vehicles, animated animals, animated apparel, animated characters/character types, etc.). For example, an attribute vector, x=(x1, x2, x3, x4, xn) may be mapped to f(x)=confidence(class).

According to some aspects of this disclosure, object and/or object type classification performed by the content analysis module 132 may employ a probabilistic and/or statistical-based analysis. According to some aspects of this disclosure, object and/or object type classification performed by the content analysis module 132 may use any type of directed and/or undirected model classification approaches include, e.g., naïve Bayes, Bayesian networks, decision trees, neural networks, fuzzy logic models, and probabilistic classification models providing different patterns of independence. Classification may also include statistical regression that is utilized to develop models of priority.

According to some aspects of this disclosure, classifiers, for example, such as cartoon object classifiers and/or the like, used by the content analysis module 132 may be explicitly trained based on labeled datasets relating to various objects depicted in content items, such as cartoon objects. According to some aspects of this disclosure, classifiers, for example, such as cartoon object classifiers and/or the like, used by the content analysis module 132 may be implicitly trained (e.g., via results from object classification tasks, etc.). For example, the content analysis module 132 may include support vector machines configured via a learning or training phase within a classifier constructor and feature selection module. Thus, the classifier(s) may be used to automatically learn and perform functions, including but not limited to object identification and similarity analysis for content acquisition.

Object Identification, Similarity Analysis, and Content Acquisition

Referring to FIG. 1, the media devices 106 may exist in thousands or millions of media systems 104. Accordingly, the media devices 106 may lend themselves to crowdsourcing embodiments. In some embodiments, one or more components and/or devices of the system server(s) 126 (e.g., crowdsource server(s) 130, machine learning model 132, etc.) operate to facilitate object identification and similarity analysis for content acquisition.

Popular content routinely includes attractive content objects (e.g., characters, actors, devices, vehicles, etc.). For example, top popular content such as but not limited to, popular and/or routinely requested animated content items within a content distribution system and/or from a content source (e.g., the content server(s) 120, etc.), may contain many attractive cartoon objects (e.g., colorful automobiles, fanciful designs, animals, toys, etc.). Users, viewers, content consumers, and/or the like may indicate attractive content objects via online surveys, portals, and/or other feedback processes. However, conventional content distribution systems/devices, content management systems/devices, content access systems/devices, and/or the like are unable to identify the most popular content objects to support content acquisition requests, proposals, and/or the like without participation and/or manual effort from users, viewers, content consumers, etc.

The multimedia environment 102 (and/or methods and/or computer program products described herein) for object identification and similarity analysis for content acquisition can enable popular cartoon objects that are attracting users to be identified and content/content items with similar cartoon objects to be requested, acquired, and/or obtained. According to some aspects of this disclosure, the system server(s) 126, for example, via the crowdsource server(s) 130, etc., may use information received from the media devices 106 (e.g., in the thousands and millions of media systems 104, etc.) to identify popular content and/or content items. For example, the crowdsource server(s) 130 may provide an indication of an amount of requests, views, accesses, and/or the like for content and/or content items occurring within a given period to identify the most popular content and/or content items.

According to some aspects of this disclosure, the system server(s) 126, for example, via the content analysis module 132, etc., may identify similarities and overlaps between content and/or content items, including but not limited to popular objects indicated by the content and/or content items. For example, according to aspects of this disclosure, the system server(s) 126 may use the crowdsource server(s) 130 and the content analysis module 132 to determine the most engaged content titles across different user cohorts, extract (e.g., identify, select, etc.) clusters of cartoon objects from the most engaged content titles, and use the most popular cartoon objects for content acquisition requests, proposals, and/or the like.

According to some aspects of this disclosure, the system server(s)(s) 126 may identify content and/or content items (e.g., content and/or content items provided by the content server(s) 120, etc.). The system server(s)(s) 126 may identify aspects and/or attributes of content and/or content items. For example, the system server(s) 126 may use the crowdsource server(s) 130 to identify aspects and/or attributes of objects depicted within content and/or content items. For example, the crowdsource server(s) 130 may indicate (and/or provide information that may be analyzed to indicate) to the system server(s)(s) 126 the most engaged (e.g., requested, accessed, displayed, communicated, etc.) content items (e.g., animated shows, cartoons, programs, videos, etc.) by various cohorts (e.g., media devices(s) 106, user types, device types, etc.). For example, the most requested and/or most popular cartoons and/or animated shows may be indicated, identified, and/or determined.

According to some aspects of this disclosure, objects that appear (e.g., are indicated, represented, included, etc.) the most in the most engaged content items may be used to determine target demographic information for the most engaged content items. For example, cartoon objects (e.g., animated vehicles, animated animals, animated clothing types, etc.) included with the most requested and/or most popular cartoons and/or animated shows may be identified, and the system server(s)(s) 126 may use the content analysis module 132 to forecast and/or indicate corresponding demographic information.

According to some aspects of this disclosure, additional content items associated with demographic information that corresponds to the target demographic information for the most engaged content items, and include enough similar objects as the objects that appear the most in the most engaged content items, may be requested, selected, acquired, and/or the like. For example, if a popular cartoon and/or animated show includes multiple occurrences of race cars, and the animation and/or type of representation for the race cars suggests the cartoon and/or animated show belongs to a particular genre (e.g., anime, situational drama, children, adult, etc.), additional cartoons and/or animated shows that correspond to the genre and include a certain amount of occurrences of race cars (or similar objects) may be requested.

According to some aspects of this disclosure, to facilitate object identification and similarity analysis for content acquisition, the content analysis module 132 may be trained to determine correspondences between content items, for example, based on objects (e.g., cartoon objects, etc.) depicted by the content items. Training content acquisition to the content analysis module 132 to determine correspondences between content items may assist content acquisition systems, devices, components, users, and/or the like target specific cohorts during a content acquisition process. For example, a business operated/associated content acquisition system, device, component, user, and/or the like with an intent to focus on acquiring more users, viewers, devices, and/or the like associated with children of a particular age group (e.g., 2-4 years of age, etc.) may use data/information output by the content analysis module 132 (e.g., an indication of the most popular cartoon objects in the most popular content items, etc.) to propose content and/or content items to the users, viewers, devices, and/or the like associated with children of the particular age group.

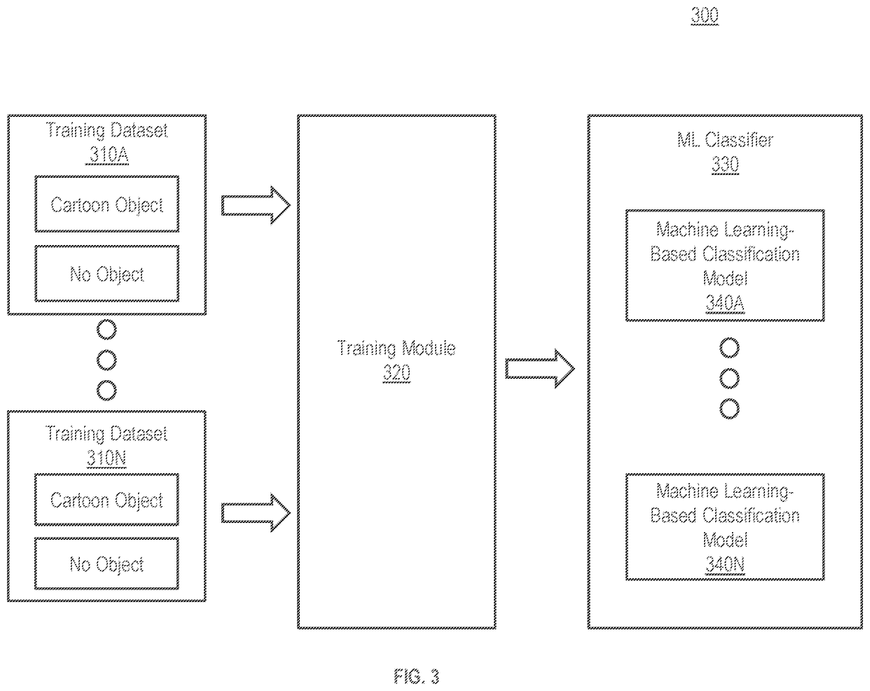

FIG. 3 is an example system 300 for training the content analysis module 132 to determine a correspondence between content items, for example, based on objects (e.g., cartoon objects, etc.) depicted by the content items, according to some aspects of this disclosure. FIG. 3 is described with reference to FIG. 1. According to some aspects, the content analysis module 132 may be trained to determine the popularity of content items, items, for example, based on historic and/or current requests for the content items. According to some aspects, the content analysis module 132 may be trained to recommend content items, for example, to users (e.g., the media device(s) 106,) and/or devices/entities responsible for acquiring content from content sources (e.g., the content servers(s) 120, etc.). According to some aspects, the content analysis module 132 may be trained to determine a correspondence between content items, for example, based on objects (e.g., cartoon objects, etc.) depicted by the content items.

The system 300 may use machine learning techniques to train at least one machine learning-based classifier 330 (e.g., a software model, neural network classification layer, etc.). The machine learning-based classifier 330 may be trained by the content analysis module 132 based on an analysis of one or more training datasets 310A-310N. The machine learning-based classifier 330 may be configured to classify features extracted from content and/or content items, for example, such as content and/or content items received from the content server(s) 120 of FIG. 1. The machine learning-based classifier 330 may classify features extracted from content and/or content items to identify an object, such as a cartoon object, and determine information about the object, such as an object type, a shape, an artistic style, a color, a size, a character type, and/or any other attribute.

The one or more training datasets 310A-310N may comprise labeled baseline data such as labeled object types (e.g., various cartoon objects, etc.), labeled object scenarios (e.g., trucks racing, kids singing, a train moving on a track, etc.), labeled demographic information (e.g., data mapping objects and/or object types to demographic characteristics, such as bright colored vehicles corresponding to kids ages 1-4, etc.), and/or the like. The labeled baseline data may include any number of feature sets. Feature sets may include, but are not limited to, labeled data that identifies extracted features from content, content items, and/or the like. For example, according to some aspects, feature sets may include, but are not limited to, labeled data that identifies various objects detected for movies.

The labeled baseline data may be stored in one or more databases. Data (e.g., content item data, etc.) for object identification, similarity analysis, and/or content acquisition operations may be randomly assigned to a training dataset or a testing dataset. According to some aspects, the assignment of data to a training dataset or a testing dataset may not be completely random. In this case, one or more criteria may be used during the assignment, such as ensuring that similar objects, similar object types, similar depicted scenarios, similar demographic characteristic pairings, dissimilar objects, dissimilar object types, dissimilar depicted scenarios, dissimilar demographic characteristic pairings, and/or the like may be used in each of the training and testing datasets. In general, any suitable method may be used to assign the data to the training or testing datasets.

The content analysis module 132 may train the machine learning-based classifier 330 by extracting a feature set from the labeled baseline data according to one or more feature selection techniques. According to some aspects, the content analysis module 132 may further define the feature set obtained from the labeled baseline data by applying one or more feature selection techniques to the labeled baseline data in the one or more training datasets 310A-310N. The content analysis module 132 may extract a feature set from the training datasets 310A-310N in a variety of ways. The content analysis module 132 may perform feature extraction multiple times, each time using a different feature-extraction technique. In some instances, the feature sets generated using the different techniques may each be used to generate different machine learning-based classification models 340. According to some aspects, the feature set with the highest quality metrics may be selected for use in training. The content analysis module 132 may use the feature set(s) to build one or more machine learning-based classification models 340A-340N that are configured to determine and/or predict objects, object types, depicted scenarios, demographic characteristic pairings, content item-related metrics (e.g., content item streaming times/periods, runtimes, viewership, licenses, etc.), and/or the like.

According to some aspects, the training datasets 310A-310N and/or the labeled baseline data may be analyzed to determine any dependencies, associations, and/or correlations between objects, object types, depicted scenarios, demographic characteristic pairings, content item-related metrics (e.g., content item streaming times/periods, runtimes, viewership, licenses, etc.), and/or the like in the training datasets 310A-310N and/or the labeled baseline data. The term “feature,” as used herein, may refer to any characteristic of an item of data that may be used to determine whether the item of data falls within one or more specific categories. For example, the features described herein may comprise objects, object types, depicted scenarios, demographic characteristic pairings, object attributes, and/or any other characteristics.

According to some aspects, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered candidate features. Any features appearing less than 2 times may be excluded from consideration as a feature. According to some aspects, a single feature selection rule may be applied to select features or multiple feature selection rules may be applied to select features. According to some aspects, the feature selection rules may be applied in a cascading fashion, with the feature selection rules being applied in a specific order and applied to the results of the previous rule. For example, the feature selection rule may be applied to the labeled baseline data to generate information (e.g., an indication of objects, object types, object attributes, depicted scenarios, demographic characteristic pairings, and/or the like, etc.) that may be used for object identification and similarity analysis for content acquisition. A final list of candidate features may be analyzed according to additional features.

According to some aspects, the content analysis module 132 may generate information (e.g., an indication of objects, object types, object attributes, depicted scenarios, demographic characteristic pairings, and/or the like, etc.) that may be used for object identification and similarity analysis for content acquisition may be based a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects, forward feature selection may be used to identify one or more candidate objects, object types, object attributes, depicted scenarios, demographic characteristic pairings, and/or the like. Forward feature selection is an iterative method that begins with no feature in the machine learning model. In each iteration, the feature which best improves the model is added until the addition of a new variable does not improve the performance of the machine learning model. According to some aspects, backward elimination may be used to identify one or more candidate objects, object types, depicted scenarios, demographic characteristic pairings, content item-related metrics (e.g., content item streaming times/periods, runtimes, viewership, licenses, etc.), and/or the like. Backward elimination is an iterative method that begins with all features in the machine learning model. In each iteration, the least significant feature is removed until no improvement is observed on the removal of features. According to some aspects, recursive feature elimination may be used to identify one or more candidate objects, object types, depicted scenarios, demographic characteristic pairings, content item-related metrics (e.g., content item streaming times/periods, runtimes, viewership, licenses, etc.), and/or the like. Recursive feature elimination is a greedy optimization algorithm that aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

According to some aspects, one or more candidate objects, object types, depicted scenarios, demographic characteristic pairings, content item-related metrics (e.g., content item streaming times/periods, runtimes, viewership, licenses, etc.), and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients. According to some aspects, embedded methods may include objects identified in content items being mapped to an embedding space to enable similarity between different objects to be identified. For example, situations, scenarios, conditions, and/or users (e.g., users/user devices that access, request, display, and/or view and/or the like content items, etc.) relationships such as “children that like puppies also like kittens,” etc. may be inferred from a graph of objects identified in content items (e.g., an embedding can be built from a graph by co-watched objects or objects that appear in the same movie, etc.).

After content analysis module 132 generates a feature set(s), the content analysis module 132 may generate a machine learning-based predictive model 240 based on the feature set(s). A machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects, the content analysis module 132 may use the feature sets extracted from the training datasets 310A-310N and/or the labeled baseline data to build a machine learning-based classification model 340A-340N to determine and/or predict objects, object types, depicted scenarios, demographic characteristic pairings, content item-related metrics (e.g., content item streaming times/periods, runtimes, viewership, licenses, etc.), and/or the like. According to some aspects, the machine learning-based classification models 340A-340N may be combined into a single machine learning-based classification model 340. Similarly, the machine learning-based classifier 330 may represent a single classifier containing a single or a plurality of machine learning-based classification models 340 and/or multiple classifiers containing a single or a plurality of machine learning-based classification models 340. According to some aspects, the machine learning-based classifier 330 may also include each of the training datasets 310A-310N and/or each feature set extracted from the training datasets 310A-310N and/or extracted from the labeled baseline data. Although shown separately, content analysis module 132 may include the machine learning-based classifier 330.

The extracted features from the imaging data may be combined in a classification model trained using a machine learning approach such as a siamese neural network (SNN); discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); other neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 330 may comprise a decision rule or a mapping that uses imaging data to determine and/or predict objects, object types, depicted scenarios, demographic characteristic pairings, content item-related metrics (e.g., content item streaming times/periods, runtimes, viewership, licenses, etc.), and/or the like.

The imaging data and the machine learning-based classifier 330 may be used to determine and/or predict objects, object types, depicted scenarios, demographic characteristic pairings, content item-related metrics (e.g., content item streaming times/periods, runtimes, viewership, licenses, etc.), and/or the like for the test samples in the test dataset. For example, the result for each test sample may include a confidence level that corresponds to a likelihood or a probability that the corresponding test sample accurately determines and/or predicts objects, object types, depicted scenarios, demographic characteristic pairings, content item-related metrics (e.g., content item streaming times/periods, runtimes, viewership, licenses, etc.), and/or the like. The confidence level may be a value between zero and one that represents a likelihood that the determined/predicted objects, object types, depicted scenarios, demographic characteristic pairings, content item-related metrics (e.g., content item streaming times/periods, runtimes, viewership, licenses, etc.), and/or the like are consistent with computed values. Multiple confidence levels may be provided for each test sample and each candidate (approximated) object, object type, depicted scenario, demographic characteristic pairing, and/or the like. A top-performing candidate object, object type, depicted scenario, demographic characteristic pairing, and/or the like may be determined by comparing the result obtained for each test sample with a computed object, object type, depicted scenario, demographic characteristic pairing, and/or the like for each test sample. In general, the top-performing candidate object, object type, depicted scenario, demographic characteristic pairing, and/or the like will have results that closely match the computed object, object type, depicted scenario, demographic characteristic pairing, and/or the like. The top-performing candidate objects, object types, depicted scenarios, demographic characteristic pairings, content item-related metrics (e.g., content item streaming times/periods, runtimes, viewership, licenses, etc.), and/or the like may be used for object identification and similarity analysis for content acquisition operations.

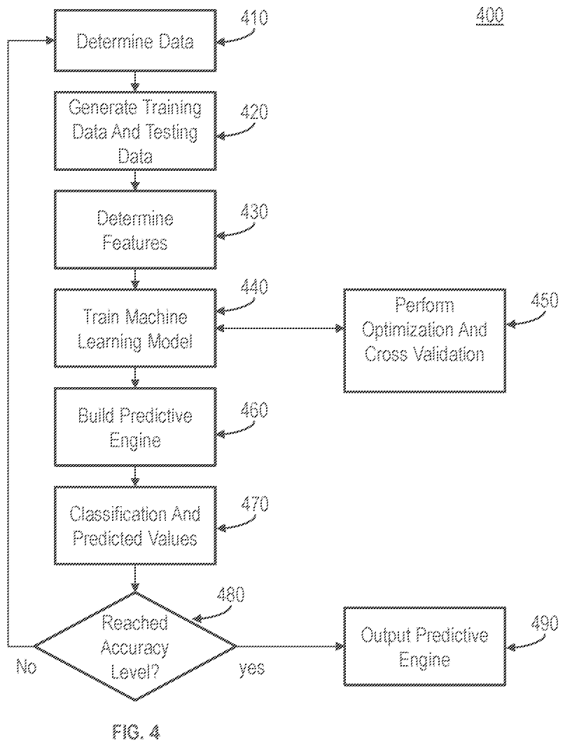

FIG. 4 is a flowchart illustrating an example training method 400. According to some aspects of this disclosure, method 400 configures machine learning classifier 330 for classification through a training process using the content analysis module 132. The content analysis module 132 can implement supervised, unsupervised, and/or semi-supervised (e.g., reinforcement-based) machine learning-based classification models 340. The method 400 shown in FIG. 4 is an example of a supervised learning method; variations of this example of training method are discussed below, however, other training methods can be analogously implemented to train unsupervised and/or semi-supervised machine learning (predictive) models. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-2. However, method 400 is not limited to the aspects of those figures.

In 410, the content analysis module 132 determines (e.g., access, receives, retrieves, etc.) a plurality of content items and/or content, for example, such as the most popular (e.g., requested, accessed, viewed, etc.) content items. Content items may be used to generate one or more datasets, each dataset associated with an object type, object scenario, object indication, and/or the like.

In 420, content analysis module 132 generates a training dataset and a testing dataset. According to some aspects, the training dataset and the testing dataset may be generated by indicating an object, object type, depicted scenario, demographic characteristic pairing, and/or the like. According to some aspects, the training dataset and the testing dataset may be generated by randomly assigning an object, object type, depicted scenario, demographic characteristic pairing, and/or the like to either the training dataset or the testing dataset. According to some aspects, the assignment of content and/or content item data as training or test samples may not be completely random. According to some aspects, only the labeled baseline data for a specific feature extracted from specific content and/or content item (e.g., depictions of a cartoon object, etc.) may be used to generate the training dataset and the testing dataset. According to some aspects, a majority of the labeled baseline data extracted from content and/or content item data may be used to generate the training dataset. For example, 75% of the labeled baseline data for determining an object, object type, depicted scenario, demographic characteristic pairing, and/or the like extracted from the content and/or content item data may be used to generate the training dataset and 25% may be used to generate the testing dataset. Any method or technique may be used to create the training and testing datasets.

In 430, content analysis module 132 determines (e.g., extract, select, etc.) one or more features that can be used by, for example, a classifier (e.g., a software model, a classification layer of a neural network, etc.) to label features extracted from a variety of content and/or content item data. One or more features may comprise indications of an object, object type, object attribute, depicted scenario, demographic characteristic pairing, and/or the like. According to some aspects, the content analysis module 132 may determine a set of training baseline features from the training dataset. Features of content and/or content item data may be determined by any method.

In 440, content analysis module 132 trains one or more machine learning models, for example, using the one or more features. According to some aspects, the machine learning models may be trained using supervised learning. According to some aspects, other machine learning techniques may be employed, including unsupervised learning and semi-supervised. The machine learning models trained in 340 may be selected based on different criteria (e.g., how close a predicted object, object type, object attribute, depicted scenario, demographic characteristic pairing, and/or the like is to an actual object, object type, object attribute, depicted scenario, demographic characteristic pairing, and/or the like, etc.) and/or data available in the training dataset. For example, machine learning classifiers can suffer from different degrees of bias. According to some aspects, more than one machine learning model can be trained.

In 450, content analysis module 132 optimizes, improves, and/or cross-validates trained machine learning models. For example, data for training datasets and/or testing datasets may be updated and/or revised to include more labeled data indicating different objects, object types, depicted scenarios, demographic characteristic pairings, content item-related metrics (e.g., content item streaming times/periods, runtimes, viewership, licenses, etc.), and/or the like.

In 460, content analysis module 132 selects one or more machine learning models to build a predictive model (e.g., a machine learning classifier, a predictive engine, etc.). The predictive model may be evaluated using the testing dataset.

In 470, content analysis module 132 executes the predictive model to analyze the testing dataset and generate classification values and/or predicted values.

In 480, content analysis module 132 evaluates classification values and/or predicted values output by the predictive model to determine whether such values have achieved the desired accuracy level. Performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined an object, object type, object attribute, depicted scenario, demographic characteristic pairing, and/or the like. Conversely, the false negatives of the predictive model may refer to the number of times the machine learning model predicted and/or determined an object, object type, object attribute, depicted scenario, demographic characteristic pairing, and/or the like incorrectly, when in fact, the predicted and/or determined object, object type, object attribute, depicted scenario, demographic characteristic pairing, and/or the like matches an actual object, object type, object attribute, depicted scenario, demographic characteristic pairing, and/or the like. True negatives and true positives may refer to the number of times the predictive model correctly predicted and/or determined an object, object type, object attribute, depicted scenario, demographic characteristic pairing, and/or the like. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 490, content analysis module 132 outputs the predictive model (and/or an output of the predictive model). For example, content analysis module 132 may output the predictive model when such a desired accuracy level is reached. An output of the predictive model may end the training phase.

According to some aspects, when the desired accuracy level is not reached, in 490, content analysis module 132 may perform a subsequent iteration of the training method 400 starting at 410 with variations such as, for example, considering a larger collection of content and/or content item data.

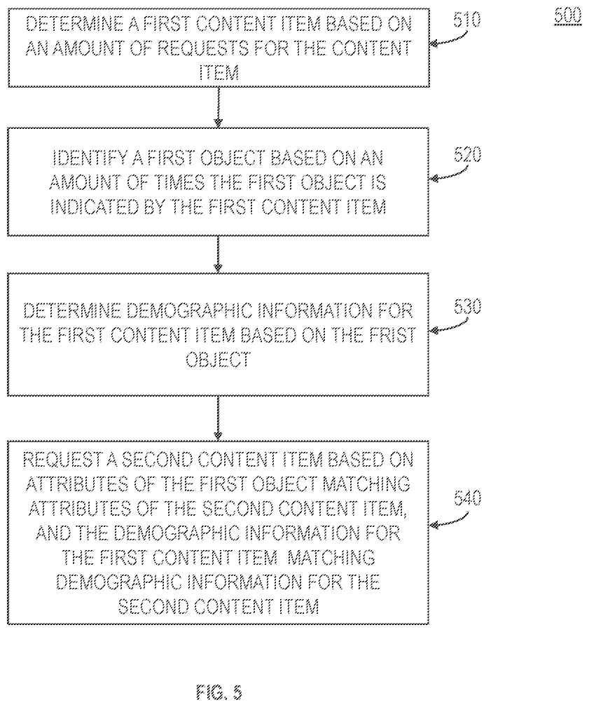

FIG. 5 shows a flowchart of an example method 500 for object identification and similarity analysis for content acquisition, according to some aspects of this disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-4. However, method 500 is not limited to the aspects of those figures. A computer-based system (e.g., the multimedia environment 102, the system server(s) 126, etc.) may facilitate object identification and similarity analysis for content acquisition.

In 510, system server(s) 126 determines a first content item. According to some aspects of this disclosure, system server(s) 126 may determine the first content item based on an amount of requests for the first content item. For example, determining the first content item may include, for each content item of a plurality of content items, determining a respective amount of requests for the respective content item. The first content item may be determined based on the amount of requests for the first content item exceeding the respective amount of requests for each content item of the plurality of content items. For example, the first content item may be the most popular content item of the plurality of content items. According to some aspects of this disclosure, the first content item may be an animated show, a cartoon, or any other type of program, video, and/or the like.

In 520, system server(s) 126 identifies a first object indicated by the first content item. According to some aspects of this disclosure, system server(s) 126 may identify the first object based on an amount of instances that the first object is indicated by the first content item.

According to some aspects of this disclosure, the first content item may be represented as list of popular objects (e.g., top (k) objects, etc.) and the system server(s) 126 may identify the first object from the list of popular objects. For example, a content item such as “Bob the Builder©” may be represented as a list/collection of construction vehicles, a cat, and/or any other popular objects, and the first object may be a construction vehicle and/or the like.

According to some aspects of this disclosure, system server(s) 126 may identify the first object indicated by the first content item by inputting the first content item into a predictive model trained to identify objects indicated in each portion of a plurality of portions of a content item. For example, system server(s) 126 may receive, from the predictive model, an indication of the amount of instances that the first object is indicated by the first content item based on an amount of instances the first object is indicated in each portion of a plurality of portions of the first content item.

According to some aspects of this disclosure, system server(s) 126 may identify the first object indicated by the first content item by determining, from descriptive information that describes objects indicated in each portion of a plurality of portions of a content item, that the first content item is indicated for the amount of instances that the first object is indicated by the first content item. For example, the descriptive information may include metadata, closed captioning data, audio description data, combinations thereof, and/or the like.

In 530, system server(s) 126 determines demographic information for the first content item. According to some aspects of this disclosure, system server(s) 126 may determine demographic information for the first content item based on the first object. For example, according to some aspects of this disclosure, system server(s) 126 may determine the demographic information for the first content item based on mapping attributes of the first object to characteristics of the demographic information. For example, system server(s) 126 may determine attributes of the first object and map the attributes to stored demographic data that indicates demographic characteristics for attributes. For example, a cartoon object such as a kitten may be mapped to a demographic group of toddler-aged viewers and/or the like. (e.g., kittens=ages 1-4, etc.). The system server(s) 126 may use any technique to determine demographic information for the first content item. For example, system server(s) 126 may determine demographic information for the first content item based on an indication of the demographic information received from a predictive model trained to forecast demographic information for objects.

In 540, system server(s) 126 requests a second content item. According to some aspects of this disclosure, the second content item may be from a list (e.g., a plurality, etc.) of potential and/or available content items to acquire, for example, from a content source. According to some aspects of this disclosure, system server(s) 126 may request the second content item based on an amount of attributes of the first object matching an amount of attributes of a second object indicated by the second content item, and the demographic information for the first content item matching demographic information for the second content item. According to some aspects of this disclosure, attributes of the first object and the attributes of the second object may include an object type, a shape, an artistic style, a color, a size, a character type, and/or any other attribute.

According to some aspects of this disclosure, method 500 may further include system server(s) 126 causing display of an interactive representation of at least one of the first object or the second object. For example, system server(s) 126 may cause a user device (e.g., a device/component of the media system 104, etc.) to display an interactive representation of the first object, the second object, and/or combinations thereof. For example, system server(s) 126 may send the interactive representation of at least one of the first object or the second object to the user device. The user device may display, for example via a user interface, the interactive representation of at least one of the first object or the second object. According to some aspects of this disclosure, system server(s) 126 may send at least one of the first content item or the second content item to the user device, for example, based on an interaction with the interactive representation.

### Example Computer System

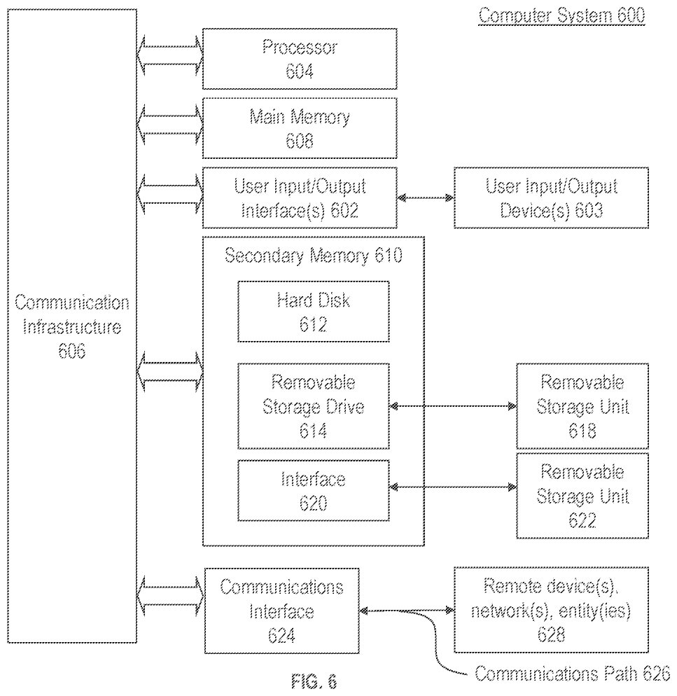

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of object identification and similarity analysis for content acquisition, comprising:
determining, by at least one computer processor, based on an amount of requests for a first content item, the first content item;
identifying, based on an amount of instances that a first object is indicated by the first content item, the first object;
determining, based on the first object, demographic information for the first content item; and
requesting, based on an amount of attributes of the first object matching an amount of attributes of a second object indicated by a second content item, and the demographic information for the first content item matching demographic information for the second content item, the second content item.

2. The computer-implemented method of claim 1, wherein the determining the first content item further comprises:
determining, for each content item of a plurality of content items, a respective amount of requests for the respective content item; and
determining, based on the amount of requests for the first content item exceeding the respective amount of requests for each content item of the plurality of content items, the first content item.

3. The computer-implemented method of claim 1, wherein the identifying the first object further comprises:
inputting, to a predictive model trained to identify objects indicated in each portion of a plurality of portions of a content item, the first content item; and
receiving an indication of the amount of instances that the first object is indicated by the first content item based on an amount of instances the first object is indicated in each portion of a plurality of portions of the first content item.

4. The computer-implemented method of claim 1, wherein the identifying the first object further comprises:
determining, based on descriptive information that describes objects indicated in each portion of a plurality of portions of a content item, that the first content item is indicated for the amount of instances that the first object is indicated by the first content item.

5. The computer-implemented method of claim 1, wherein the determining the demographic information for the first content item is further based on at least one of:
mapping attributes of the first object to characteristics of the demographic information, or
receiving an indication of the demographic information from a predictive model trained to forecast demographic information for objects.

6. The computer-implemented method of claim 1, wherein the attributes of the first object and the attributes of the second object comprise at least one of an object type, a shape, an artistic style, a color, a size, or a character type.

7. The computer-implemented method of claim 1, further comprising:
causing display of an interactive representation of at least one of the object indicated by the first content item or the object indicated by the second content item; and
sending to a user device, based on an interaction with the interactive representation, at least one of the first content item or the second content item.

8. A system for object identification and similarity analysis for content acquisition, comprising:
at least one processor configured to perform operations comprising:
determining, based on an amount of requests for a first content item, the first content item;
identifying, based on an amount of instances that a first object is indicated by the first content item, the first object;
determining, based on the first object, demographic information for the first content item; and
requesting, based on an amount of attributes of the first object matching an amount of attributes of a second object indicated by a second content item, and the demographic information for the first content item matching demographic information for the second content item, the second content item.

9. The system of claim 8, wherein the determining the first content item further comprises:
determining, for each content item of a plurality of content items, a respective amount of requests for the content item; and
determining, based on the amount of requests for the first content item exceeding the respective amount of requests for each content item of the plurality of content items, the first content item.

10. The system of claim 8, wherein the identifying the first object further comprises:
inputting, to a predictive model trained to identify objects indicated in each portion of a plurality of portions of a content item, the first content item; and
receiving an indication of the amount of instances that the first object is indicated by the first content item based on an amount of instances the first object is indicated in each portion of a plurality of portions of the first content item.

11. The system of claim 8, wherein the identifying the first object further comprises:
determining, based on descriptive information that describes objects indicated in each portion of a plurality of portions of a content item, that the first content item is indicated for the amount of instances that the first object is indicated by the first content item.

12. The system of claim 8, wherein the determining the demographic information for the first content item is further based on at least one of: mapping attributes of the first object to characteristics of the demographic information, or receiving an indication of the demographic information from a predictive model trained to forecast demographic information for objects.

13. The system of claim 8, wherein the attributes of the first object and the attributes of the second object comprise at least one of an object type, a shape, an artistic style, a color, a size, or a character type.

14. The system of claim 8, the operations further comprising causing display of an interactive representation of at least one of the object indicated by the first content item or the object indicated by the second content item; and
sending to a user device, based on an interaction with the interactive representation, at least one of the first content item or the second content item.

15. A non-transitory computer-readable medium having instructions stored thereon that, when executed by at least one computing device, cause the at least one computing device to perform operations for object identification and similarity analysis for content acquisition, the operations comprising:
determining, based on an amount of requests for a first content item, the first content item;
identifying, based on an amount of instances that a first object is indicated by the first content item, the first object;
determining, based on the first object, demographic information for the first content item; and
requesting, based on an amount of attributes of the first object matching an amount of attributes of a second object indicated by a second content item, and the demographic information for the first content item matching demographic information for the second content item, the second content item.

16. The non-transitory computer-readable medium of claim 15, wherein the determining the first content item further comprises:
determining, for each content item of a plurality of content items, a respective amount of requests for the content item; and
determining, based on the amount of requests for the first content item exceeding the respective amount of requests for each content item of the plurality of content items, the first content item.

17. The non-transitory computer-readable medium of claim 15, wherein the identifying the first object further comprises:
inputting, to a predictive model trained to identify objects indicated in each portion of a plurality of portions of a content item, the first content item; and
receiving an indication of the amount of instances that the first object is indicated by the first content item based on an amount of instances the first object is indicated in each portion of a plurality of portions of the first content item.

18. The non-transitory computer-readable medium of claim 15, wherein the identifying the first object further comprises:
determining, based on descriptive information that describes objects indicated in each portion of a plurality of portions of a content item, that the first content item is indicated for the amount of instances that the first object is indicated by the first content item.

19. The non-transitory computer-readable medium of claim 15, wherein the determining the demographic information for the first content item is further based on at least one of: mapping attributes of the first object to characteristics of the demographic information, or receiving an indication of the demographic information from a predictive model trained to forecast demographic information for objects.

20. The non-transitory computer-readable medium of claim 15, the operations further comprising causing display of an interactive representation of at least one of the object indicated by the first content item or the object indicated by the second content item; and
sending to a user device, based on an interaction with the interactive representation, at least one of the first content item or the second content item.
